(19) United States
(12) Patent Application Publication
(10) Pub. No.: US 2011/0075316 A1
(43) Pub. Date: Mar. 31, 2011

(54) SYSTEM FOR RECOVERING AND USING THE ELECTROSTATIC CHARGE GENERATED BY LIGHTNING

(76) Inventors: Angel Rodriguez Montes, Ordino (ES); Antonio Claveria Canal, La Massana (ES)

(21) Appl. No.: 12/891,388

(22) Filed: Sep. 27, 2010

(30) Foreign Application Priority Data
Sep. 29, 2009 (ES) 200901924

(51) Int. Cl. H05F 7/00

(52) U.S. Cl. 361/225

(57) ABSTRACT

A system for the recovery and use of the electrostatic charge present in the atmosphere during storms generated by lightning, transforming natural energy into electrical energy useful for consumption, and providing the necessary protection for lives and property against electro-atmospheric phenomena, has an ecological lightning conductor, an electrical conductor connected by one end to the low-frequency electrode of the lightning conductor, and an enhanced intelligent earth wire, whereto the conductor is joined by its other end. The conductor includes a series of probes and magnetic field detectors which will send information to the microprocessor and from there to the mainframe computer. The control device allows regulation of the earth resistance, thereby generating more or less charge, diverting the energy to the accumulators or to earth through dissipator electrodes.

### CROSS-REFERENCE TO RELATED APPLICATION

The invention described and claimed hereinbelow is also described in Spanish Patent Application ES 2009 01924 filed on Sep. 29, 2009. This Spanish Patent Application, whose subject matter is incorporated here by reference, provides the basis for a claim of priority of invention under 35 U.S.C. 119(a)-(d)

### BACKGROUND OF THE INVENTION

The present invention relates to a system which allows the recovery and use of the electrostatic charge present in the atmosphere during storms which generates lightning, thereby achieving the transformation of natural energy into electrical energy useful for domestic and industrial consumption, while providing essential and adequate protection to persons, animals and property against the aforementioned atmospheric electrical phenomena.

Different technical and scientific arguments relative to the effective application of the system that is the object of this invention will be explained in detail in this description, in addition to describing the elements that compose the aforementioned system.

During an atmospheric storm formation process, variable electrical fields appear which are responsible for the generation and appearance of lightning, which are discharges between the ground and the atmosphere. As a result of the generation of electrical charges within the cloud, the atmosphere increases its electrical potential, inducing a variable ground voltage.

It has been scientifically proven that if this ground voltage is controlled, the current flowing through the ground can also be controlled, thereby adequately leveraging the full potential of this energy.

This will primarily avoid the electrical saturation of that area, which could call, excite or create a lightning bolt therein and, secondly, this energy may be accumulated in the most adequate manner.

This process for recovering energy from the atmosphere is carried out before and during the first phase of the generation of lightning charges. The effect of attenuating the electrical field of the atmosphere causes the disappearance of the lightning discharge to ground, on not having sufficient potential for formation thereof, thereby allowing prevention and protecting persons, animals and property.

Widely known are the experiments and achievements of Benjamin Franklin in the 18^{th} century, inventor of the passive lightning conductor equipped with a priming device or those developed subsequently using the “multipoint” system, the action of which is based on ionisation and excitation, constant or by impulses, of the electro-atmospheric field in order to capture the lightning discharge.

Mention must be made of radioactive lightning conductors, currently in disuse for evident safety reasons due to radiation hazard; likewise, other devices based on the filtration of high frequencies and harmonic components are also known to exist, equipped with two or more external electrical connections and having different components such as coils, resistors and condensers, duly connected and having the necessary siliceous sand for absorbing the thermal inertia produced when the system functions as a whole.

Reference is made herein to patent of invention P 200202884/2, by the same inventors, which relates to a deionising lightning conductor of electrostatic charge, based on three insulators equipped with a variable noble gas dielectric in its interior.

According to the data provided by the world meteorological detection system, more than four thousand storms form in the Earth's atmosphere every day, which generate around eight million lightning bolts.

The phenomenon called “lightning” is the electrical reaction caused by the saturation of electrostatic charges generated by the progressive accumulation of an electric field between the ground and the cloud, during the activation of a typical storm.

This phenomenon is randomly present as of an electro-atmospheric potential of 10/45 kV. It is generated between two points of attraction of different polarity and same potential for the purpose of compensating the saturation of the electrostatic charge. Lightning charge density is proportional to the saturation of the electrostatic charge of the area: the higher the charge density, the higher the risk of generating a tracker or “leader” and, subsequently, a lightning discharge.

Lightning charge intensity is variable, depending on the critical moment when the resistance in the air between the two transfer points break down; it will also be influenced by serially exposed materials such as soils, rocks, wood, iron or other metals, lightning conductors, earth wires, etc. A lightning bolt can transport an average charge of 20 GW of power per second, equivalent to one hundred million ordinary incandescent light bulbs.

This electrical phenomenon is represented in the form of an electronic shadow, which determines the elements that will be affected by charge exchange.

Studies carried out on the electro-atmospheric field at ground level reveal that charge distribution during the generation of the high-voltage field is not static but rather dynamic, on being randomly formed and generating the moving tracker or leader and different geographical points at the same time. The intensity and location of this electronic shadow can change radically and affect the low or lateral areas of high structures or buildings.

The behavioural study of a conventional pointed lightning conductor has demonstrated that they generate, to a greater or lesser extent, electromagnetic effects in the installations themselves, as well as in neighbouring installations, upon capturing the lightning bolt. In the case of ionising lightning conductors, accidents frequently occur for this reason.

Recently, enhancements made in electrostatic charge deionising lightning conductors through the application and incorporation of new technologies, such as a special cable adaptable to different forms of energy transport, eliminates causes of accidents and improves the reliability of the facilities, in addition to acting within an ecological electrical environment free of electromagnetic interferences.

### SUMMARY OF THE PRESENT INVENTION

Accordingly, it is an object of the present invention to provide a new system which allows recovering and using the electrostatic charge generated by lightening and provides for highly advantageous results.

In keeping with these objects this system allows to cover all levels of electrical risk, diversity in the type and polarity of lightning bolts for any type of structure. It is an individual and collective protection system which bases its operating principle on the orderly transformation of ions flowing in a current, and is useful for working at low voltages and previously be derived to an accumulation area.

The system is composed of an external electrode acting as an ecological lightning conductor, an electric conductor, designed and calculated for a wide range of frequencies, and having anti-corrosive protection and an intelligent earth wire, complemented by energy accumulators and dissipator electrodes, capable of deriving all current leakage to earth, all of said components being controlled by a microprocessor which manages the energy as it appears, controlling its intensity, as well as the charge of the aforementioned accumulators for subsequent consumption.

The system also incorporates an alarm-based alert device, both private and public, for occupational risk prevention management against lightning risk.

At meteorological level, the system allows data to be obtained relative to the behaviour of the electric field, temperatures, atmospheric pressure, humidity and quantity of discharges.

The invention being described incorporates magnetic field detectors and detectors for controlling earth leakage current intensity, for subsequent analysis thereof and the consequent alarms. These detectors send the information to the microprocessor, upon recording the abrupt magnetic field variations.

The deionisation system of the lightning conductor itself facilitates the appearance of small currents in the earth wire, where charges are intelligently accumulated for subsequent use thereof. Depending on the intensity of the natural earth electric field, the ecological lightning conductor system generates the appearance of an earth leakage current which passes through the electrical conductor from the lightning conductor, strictly speaking, to the earth wire. The automatic control system regulates earth resistance in order to generate more or less charge and divert energy to the accumulators or to the enhanced intelligent earth wire.

The intelligent earth wire incorporates an electronic system which automatically regulates its own electrical resistance with reference to the physical earth. This control system allows controlled energy transfer, maintaining a resistance of less than 5 ohms in the earth installation during the four seasons of the year and varying, as required, the electrical conductivity of the physical earth and its humidity in order to facilitate or stop leakage currents.

The intelligent earth wire consists of special electrodes, according to the type of soil and/or terrain, aimed at facilitating current leakage and avoiding corrosion of the metals. These electrodes are installed conveniently protected against the aggressiveness of any chemical or electrochemical reaction.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a longitudinal diagram of the system in accordance with the present invention, illustrating the layout of the different components thereof;

FIG. 2 shows an outer view of the ecological lightning conductor of the inventive system; and

FIG. 3 is a complementary view of the preceding figure, showing a fully sectional view of the lightning conductor of the inventive system.

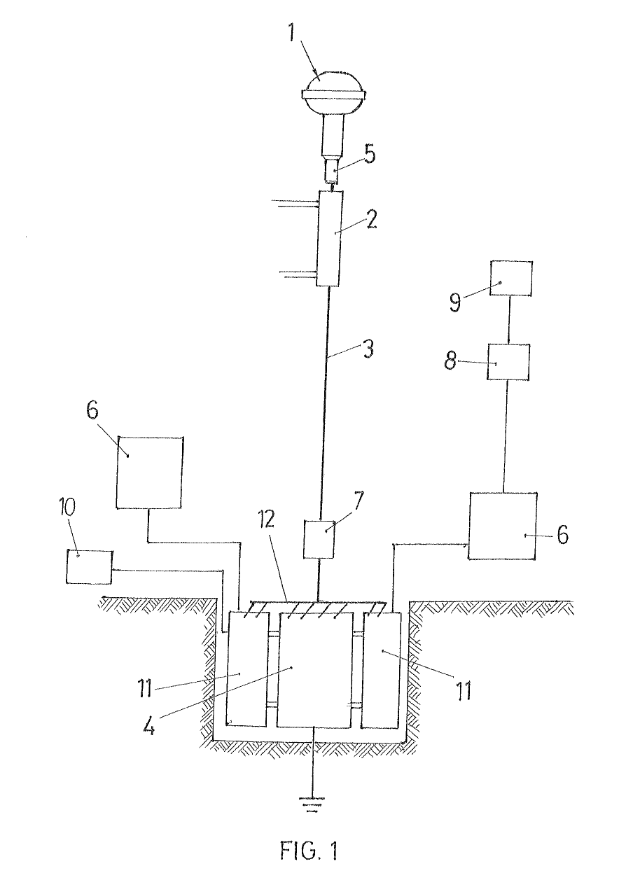

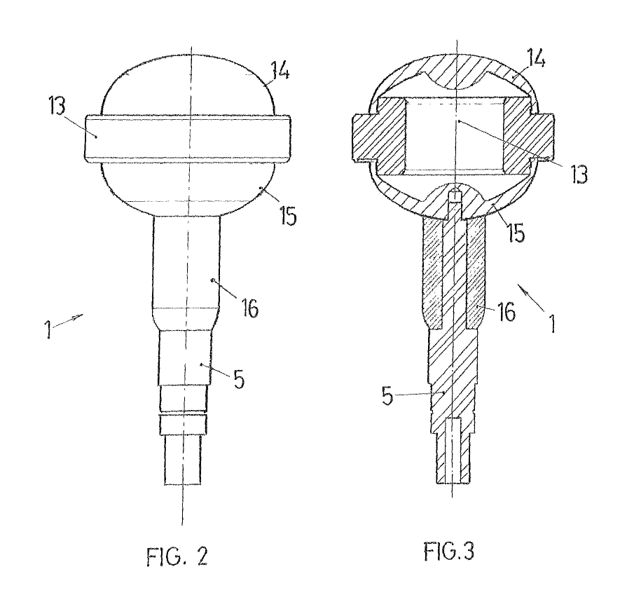

### DESCRIPTION OF THE PREFERRED EMBODIMENTS

A system for recovering and using the electrostatic charge generated by the lightning of the present invention includes an ecological lightning conductor 1, disposed on a mast 2, which is installed at the highest point of the existing structure by means of adequate bearings or on a newly built tower, an electrical conductor 3 and an intelligent earth wire 4.

The electrical conductor 3 is connected by one end to the mast or low electrical resistance electrode 5 of the lightning conductor 1, and connected to the intelligent earth wire 4 by the other end, said conductor incorporating a series of probes 6 and magnetic field detectors 7 that will send information to the microprocessor 8.

These data, recorded by the microprocessor 8, are sent to a mainframe computer 9 where they are processed, being immediately displayed on a screen or sent to an “Internet”-type data transport network.

The intelligent earth wire 4 is equipped with a control device 10 which will analyse, in real time, the earth current leakages, sending the data to the aforementioned mainframe computer 9. Depending on the intensity of the leakage, the system will manage the information, generating alarms or modifying the processes for sending current to the energy accumulators 11, disposed next to the intelligent earth wire 4. This earth wire 4 also has dissipator electrodes 12 at ground level.

The ecological lightning conductor 1 has a toroidal-shaped body 13, closed by its upper part by an upper frame 14 and completed by a lower frame 15 whereto, in the central appendix 16 of its lower part, is fixed to the mast or low electrical resistance electrode 5.

The dielectric product, which is essential for the object to act as a lightning conductor in itself, is disposed in the interior of the toroidal body 13 of the ecological lightning conductor. The dielectric product can be of noble gas.

The previously described characteristics of the ecological lightning conductor confer the quality of deionising lightning conductor to this system component, which allows the appearance, as mentioned earlier, of small currents in the intelligent earth wire 4, where the charges are accumulated for their subsequent consumption in the energy accumulators 11.

During a storm process, a high-voltage field is generated at ground level which is proportional to the charge of the cloud and the distance that separates it from the ground.

As of a certain magnitude of the natural electric field on the physical earth, the equipotential installation of earth wires of the system facilitates transfer of the charges through the electrical conductor 3, charges which, regardless of their polarity, are concentrated on the mast or lower electrode 5 of the lightning conductor 1, disposed at the highest point of the installation that configures the system, which is connected to the earth wire by means of the electrical conductor 3. The current that circulates through the lightning conductor-conductor-earth wire system is proportional to the charge within the cloud.

The low resistance of this mast or lower electrode 5 of the lightning conductor 1, facilitates the capture of opposing charges in the electrode or upper body 13. During this energy transfer process, a small current flow takes place between the cathode and anode in the interior of the lightning conductor, in the direction of the current flow.

The resulting effect causes the appearance of a weak leakage current that derives to the electrical earth wiring of the installation, which is controlled by a microprocessor 8 which, in turn, causes current shunting to an accumulation system 11 or to dissipator electrodes 12 at ground level.

The evolution of the electro-atmospheric phenomenon is recorded in a database by means of electric probes 6 installed in the electrical conductor 3, disposed between the lightning conductor 1 and intelligent earth wire 4, and magnetic field detectors 7. The data are stored, in real time, in a microprocessor 8 thanks to the transfer of data from the probes 6 to the mainframe computer 9, via radio or conductor. These data may be viewed on a PC screen and statistics calculated, both real time and historical, for the purpose of carrying out electromagnetic and electrical prevention studies.

The novel technology of the system that is the object of the invention, and which is being described, allows optimisation of industrial process management and enhancement of personal electrical safety.

Depending on the intensity of the current that flows through the conductor 3 towards the earth wire 4, high electric field alarms may be generated, consequently alerting of the risk of electrical storm in the area, with lightning activity.

Having sufficiently described the characteristics of the system that is the object of the present invention, we must point out that any variation in dimensions, shapes, types of materials and layout of the different components shall not alter the essentiality of the invention and may be necessary according to the protection requirements of the desired area, based on factors such as the geographical area, environmental context and dimensions.

It will be understood that each of the elements described above, or two or more together, may also find a useful application in other types of constructions differing from the types described above.

While the invention has been illustrated and described as embodied in a system for recovering and using the electrostática charge generated by ligntening, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A system for recovering and using an electrostatic charge generated by lightning and being present in an atmosphere during storms for transforming a natural energy into electrical energy and providing a necessary protection to persons, animals and property, the system comprising components including an element selected from the group consisting of an external electrode and an ecological lightning conductor, a mast fixing said electrode, an intelligent earth wire, an electrical conductor joining said element to said intelligent earth wire, energy accumulators, dissipation electrodes, electric probes, magnetic field detectors, and a microprocessor controlling all the components of the system and transferring data to a mainframe computer.

2. A system for recovering and using the electrostatic charge as defined in claim 1, wherein said ecological lightning conductor has a toroidal-shaped body housing containing a dielectric product, an upper frame closing said body, a lower frame completing said body, and a lower central appendix in which a member selected from a group consisting of said mast and a low electrical resistance electrode is fixed.

3. A system for recovering and using the electrostatic charge as defined in claim 2, wherein said toroidal-shaped boyd of said ecological lightening conductor contains a noble gas.

4. A system for recovering and using the electrostatic charge as defined in claim 1, wherein said electrical conductor has one end connected to a member selected from the group consisting of a mast and an electrode and is designed for a wide range of frequencies and has adequate anti-corrosion protection, said electrical conductor also having another end joined to said intelligent earth wire, said electrical conductor incorporating said electric probes and said magnetic field detectors.

5. A system for recovering and using the electrostatic charge as defined in claim 1, wherein said intelligent earth wire is provided with disipator electrodes at a ground level according to a type of a component selected from the group consisting of soil, terrain and both.

6. A system for recovering and using the electrostatic charge as defined in claim 1, further comprising a control device analyzing earth current leakages in real time and sending data to the mainframe computer, generating according to a leakage intensity, alarms or modifying a process for sending current to said accumulators.
